(19) United States
(12) Patent Application Publication
(10) Pub. No.: US 2026/0321658 A1
(43) Pub. Date: Oct. 15, 2026

(54) CARBON FIBER SUPPORT FOR A LITHIUM METAL NEGATIVE ELECTRODE AND A METHOD FOR MANUFACTURING THE SAME

(71) Applicants: HYUNDAI MOTOR COMPANY, Seoul (KR); KIA CORPORATION, Seoul (KR); Gwangju Institute of Science and Technology, Gwangju (KR)

(72) Inventors: Seungjong Lee, Hwaseong-si (KR); Jongchan Song, Hwaseong-si (KR); Areum Ha, Hwaseong-si (KR); Seongmin Ha, Hwaseong-si (KR); Seongju Hwang, Hwaseong-si (KR); Yunseo Jeoun, Hwaseong-si (KR); Sangheon Lee, Hwaseong-si (KR); Seoyoung Choi, Hwaseong-si (KR); Kwang Sup Eom, Gwangju (KR); Jinhyeon Jo, Gwangju (KR)

(73) Assignees: HYUNDAI MOTOR COMPANY, Seoul (KR); KIA CORPORATION, Seoul (KR); Gwangju Institute of Science and Technology, Gwangju (KR)

(21) Appl. No.: 19/451,795

(22) Filed: Jan. 16, 2026

(30) Foreign Application Priority Data
Apr. 14, 2025 (KR) 10-2025-0048099

(51) Int. Cl. H01M 4/62; H01M 4/02; H01M 4/04; H01M 4/36

(52) U.S. Cl. CPC H01M 4/628; H01M 4/0404; H01M 4/366; H01M 4/625; H01M 2004/021

(57) ABSTRACT

A carbon fiber support includes a current collector and a lithium-containing layer including a conductive carbon fiber and disposed on the current collector, wherein lithium in the lithium-containing layer has a lithium concentration gradient in which a lithium concentration gradually decreases as a distance from the current collector increases, and the lithium-containing layer further includes pores therein.

### CROSS-REFERENCE TO RELATED APPLICATION

This application claims priority to and the benefit of Korean Patent Application No. 10-2025-0048099 filed with the Korean Intellectual Property Office on Apr. 14, 2025, the entire contents of which are incorporated herein by reference.

### TECHNICAL FIELD

The present disclosure relates to a carbon fiber support for a lithium metal negative electrode and a method of manufacturing the same.

### BACKGROUND

Climate changes caused by environmental pollution and global warming are causing environmental disasters and threatening life. Accordingly, alternatives to internal combustion engines that can carry out environment-friendly energy storage/transfer processes are being researched. Among them, rechargeable lithium batteries, which do not discharge carbon during the storage/transfer processes and have high energy density and output density, are attracting attention as a power source for not only small electronic devices but also environment-friendly electric vehicles.

As a next generation negative electrode material for the rechargeable lithium batteries, lithium metal, which has high theoretical capacity (3862 mA h g⁻¹, 2046 mA h cm⁻³) and a low standard redox potential (−3.03 V_{SHE(standard hydrogen electrode)}), may replace a conventional graphite negative electrode and significantly increase energy density and output density of the batteries, is attracting attention. However, there are safety and stability issues such as reduced cycle-life performance due to lithium electrodeposition during the charge/discharge, fire and explosion due to cell short-circuit, and the like.

Accordingly, a method of suppressing the dendrite formation by reducing effective current density by securing a large electrochemically active surface area of a conductive porous structure has been proposed. However, a problem that the lithium is actually electrodeposited not inside the structure but rather on the outside with low resistance due to diffusion resistance of lithium ions during the lithium electrodeposition has been reported. In order to improve this phenomenon, a method of coating a lithium affinity material on a structure such as a copper (Cu) foam or a carbon paper has been developed. Herein, this process has induced the internal lithium electrodeposition but had a problem of not being suitable for large-area electrodes and significantly reducing capacity per weight/volume due to high thickness and weight and thus turned out to be not suitable for manufacturing batteries with commercially required energy density and output density.

The statements in this Background section merely provide background information related to the present disclosure and may not constitute prior art.

### SUMMARY

In view of the foregoing, in order to maintain high capacity per weight/volume, it is advantageous to manufacture a porous structure having a reduced thickness, high porosity, and a low weight. In addition, the structure needs to be easily implemented into the large-area electrodes. One ore more aspects of the present disclosure provide a carbon fiber support for a lithium metal negative electrode and a method of manufacturing the same.

The technical problem to be solved by the present disclosure is to maintain a high capacity per weight/volume through a carbon fiber/tube structure having a lithium affinity gradient, and to minimize changes in the thickness of the electrode by inducing internal electrodeposition of lithium during the charge/discharge process.

According to an embodiment, a carbon fiber support for a lithium metal negative electrode includes a current collector and a lithium-containing layer including a conductive carbon fiber and disposed on the current collector. Lithium in the lithium-containing layer has a lithium concentration gradient in which a lithium concentration gradually decreases as it moves away from the current collector (e.g., a distance from the current collector increases), and the lithium-containing layer further includes pores therein.

According to another embodiment, a method for manufacturing a carbon fiber support for a lithium metal negative electrode includes: mixing a conductive carbon fiber treated with a lithium ion affinity element and a pore forming agent to prepare a powder; adding a binder and a solvent to the powder to prepare a slurry; casting the slurry on a current collector; drying the slurry casted on the current collector; casting a mixture of a binder, a solvent, and a powder which is prepared by mixing a conductive carbon fiber that are not treated with a lithium ion affinity element and a pore forming agent, onto the dried slurry; drying the mixture; and etching after the drying.

According to an embodiment of the present disclosure, a lithium-affinity gradient suitable for manufacturing a large-area electrode may be implemented by using lithium-affinity silver-treated carbon fibers/tubes and lithium affinity silver-untreated carbon fibers/tubes together, and a porous structure with controllable porosity and thickness can be provided. A lithium metal battery including the porous structure as a carbon fiber support for a lithium metal negative electrode has the advantage of inducing the battery charging process to be deposited from the inside of the structure, increasing stability while alleviating thickness changes, and securing high energy per weight/volume.

### BRIEF DESCRIPTION OF THE DRAWINGS

FIG. 1 is a graph showing the energy density per volume/mass when various types of supports are applied.

FIG. 2 is X-ray Diffraction (XRD) analysis data of a conductive porous carbon fiber support according to Example 1.

FIG. 3 is thermogravimetric analysis (TGA) data of a conductive porous carbon fiber support according to Example 1.

FIG. 4 is a schematic view showing a method for manufacturing a support according to Comparative Example 2 and Example 1. The left side of FIG. 4 is a schematic view of a single coating of a slurry containing only carbon nanofibers that have not been treated with lithium affinity silver (Ag), and the right side of FIG. 4 is a schematic view of a double coating of a slurry containing both carbon nanofibers that have not been treated with lithium affinity Ag and carbon nanofibers that have been treated with lithium affinity Ag.

FIGS. 5A to 5C are schematic views showing the change in the shape of the support according to the increase in the NaCl ratio.

FIG. 6 shows impedance data according to the ratio of carbon nanotubes (CNTs) and NaCl.

FIG. 7 shows contact resistance data according to the ratio of carbon nanotubes (CNTs) and NaCl.

FIG. 8 shows half-cell electrochemical data according to the ratio of carbon nanotubes (CNTs) and NaCl.

FIG. 9 is a graph of electrical conductivity according to binder ratio using a two-terminal direct current resistance measurement method.

FIG. 10 shows half-cell data according to binder ratio.

FIG. 11 shows scanning electron microscope (SEM) photographs of carbon fibers with and without NaCl application according to Comparative Example 1 and Comparative Example 2.

FIG. 12 shows scanning electron microscope (SEM) photographs of the supports according to Comparative Example 2 and Example 1 after lithium electrodeposition.

FIG. 13 is a graph showing the difference in nucleation overvoltage of the supports according to Comparative Example 1, Comparative Example 2, and Example 1.

FIG. 14 shows cycle-life evaluation data of half-cells including supports according to Comparative Example 1, Comparative Example 2, and Example 1.

The drawings described herein are for illustration purposes only and are not intended to limit the scope of the present disclosure in any way.

### DETAILED DESCRIPTION

Special terms used herein is for the purpose of describing embodiments only and are not intended to be limiting of the present disclosure. Unless defined otherwise, the singular forms used herein shall be deemed to include the plural as well. The term “having,” “including,” or “comprising” used in the specification means that a specific feature, region, integer, step, operation, element and/or component is embodied and other specific features, regions, integers, steps, operations, elements, and/or components are not excluded.

Unless defined otherwise, all terms including technical and scientific terms used herein have the same meaning as commonly understood by those having ordinary skill in the art to which the present disclosure belongs. Commonly used predefined terms are further interpreted as having a meaning consistent with the relevant technical literature and the present disclosure, and are not to be construed as ideal or very formal meanings unless defined otherwise.

Terms including “first,” “second,” “third,” and the like are used for describing various arts, components, regions, layers, and/or sections, but are not limited thereto. These terms are only used to distinguish any part, component, region, layer, or section from the other part, component, region, layer, or section. Accordingly, the first part, component, region, layer, or section described below may be mentioned as the second part, component, region, layer, or section within the range without departing from the range of the present disclosure.

Also, unless specifically stated otherwise, % means wt %, and if no unit is specified separately, the unit based on weight is omitted.

As used herein, the term “combination(s) thereof” described in the expression in the Markush format refers to one or more mixtures or combinations selected from the components described in the expression in the Markush format, and refers to including at least one selected from the components. In the present disclosure, each of phrases such as “A or B”, “at least one of A and B”, “at least one of A or B”, “A, B or C”, “at least one of A, B and C”, “at least one of A, B or C” and “at least one of A, B, or C, or a combination thereof” may include any one or all possible combinations of the items listed together in the corresponding one of the phrases.

Hereinafter, embodiments are described in detail. However, these embodiments are examples, and this disclosure is not limited thereto.

### Carbon Fiber Support for Lithium Metal Negative Electrode

The present disclosure relates to a carbon fiber/tube-based support for a lithium metal negative electrode with a lithium affinity gradient and a method for manufacturing the same. The lithium metal support of an embodiment of the present disclosure may have a lithium concentration gradient by being composed of a double layer of carbon fibers/tubes treated with lithium affinity and carbon fibers/tubes not treated with lithium affinity. This lithium affinity gradient may induce a lithium plating process inside the support, thereby improving cycle-life performance and minimizing thickness changes.

The lithium metal support of an embodiment of the present disclosure may be a porous structure in which a double layer of carbon fibers/tubes subjected to lithium affinity treatment and carbon fibers/tubes not subjected to lithium affinity treatment are physically connected. Through the bottom-up process, the microscopic structure of the porous structure, such as the porosity, pore diameter, and surface area, and the macroscopic structure, such as the thickness and area of the electrode, and electrochemical properties, such as lithium affinity treatment, may be easily controlled. By utilizing a pore forming agent such as NaCl in the bottom-up process, a support with high porosity may be produced without using toxic substances. By controlling the optimal ratio of a pore forming material (e.g., NaCl, and the like) and the ratio of a binder for controlling electrical conductivity, the phenomenon of lithium being deposited on the upper portion of the support through a lithium affinity gradient may be prevented and internal electrodeposition of lithium may be induced.

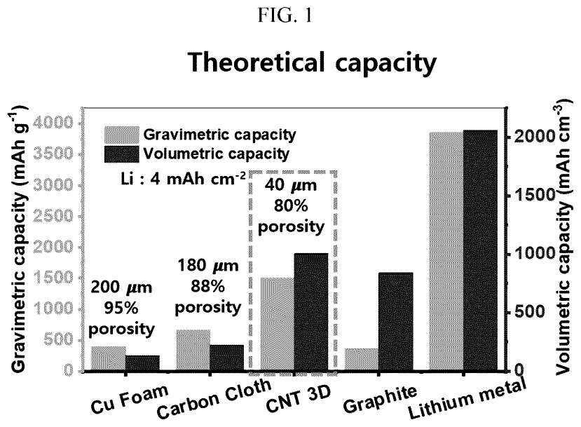

As in FIG. 1, copper (Cu) foam and carbon cloth, which are generally used as three-dimensional structures, have a problem of reduced energy density because their thickness is thick and cannot be controlled. However, as described below, when a structure is manufactured using carbon nanotubes (CNTs) using the manufacturing method according to an embodiment of the present disclosure, the thickness of the structure may be controlled, and since the density of the CNTs themselves is low, both the energy density per volume and mass may be secured.

In order to manufacture a conductive porous structure with a lithium affinity gradient, the lithium ion electrodeposition/desorption process should occur from the inside of the structure, thereby suppressing lithium volume expansion/contraction and maintaining a constant thickness. In addition, the effective current density should be reduced based on a large electrochemical surface area, thereby suppressing lithium dendrite growth. However, in the case of existing studies on conductive porous structures, it has been difficult to implement a lithium affinity gradient, and there has been a problem that the implementation method is not suitable for large-area electrodes like sputtering or chemical vapor deposition (CVD). In addition, by utilizing thick and heavy structures such as copper (Cu) foam or carbon paper, a phenomenon occurs in which the capacity per weight/volume is lowered compared to the electrode used. Therefore, the need for a new, unprecedented structure and its manufacturing method that can easily implement a lithium affinity gradient and has a thin thickness, high porosity, and low weight is explosively increasing.

A technology has been introduced to suppress dendrite growth over a large surface area of a structure by utilizing the characteristics of carbon materials, but there is a clear limitation that lithium electrodeposition occurs on the upper portion of the structure. An embodiment of the present disclosure has a clear difference from the prior art in that the lithium electrodeposition process is induced into the inside of the porous structure. In addition, a technology using a structure such as a metal foam/mesh has been introduced, but in this case, there is a problem in that the energy and output per weight/volume, which are advantages of lithium metal batteries, are significantly reduced due to the thick thickness and additional weight. However, an embodiment of the present disclosure is very different from the prior art in terms of configuration and effect in that the above advantages of lithium metal batteries can be fully utilized.

Specifically, a carbon fiber support for a lithium metal negative electrode according to an embodiment includes a current collector and a lithium-containing layer including a conductive carbon fiber on the current collector, wherein lithium in the lithium-containing layer has a lithium concentration gradient in which a lithium concentration gradually decreases as it moves away from the current collector, and the lithium-containing layer further includes pores therein.

For example, the negative electrode may include a current collector, and the current collector is not particularly limited as long as it is used as a negative electrode current collector of a general rechargeable lithium battery. The current collector may include, for example, copper, stainless steel, aluminum, nickel, titanium, calcined carbon, copper or stainless-steel surface-treated with carbon, nickel, titanium, silver, and the like, an aluminum-cadmium alloy, and the like. In addition, the current collector may typically have a thickness of 3 μm to 500 μm, and fine unevenness may be formed on the surface of the current collector to strengthen the bonding strength of the negative electrode active material. For example, the current collector may be used in various forms such as a film, a sheet, a foil, a net, a porous body, a foam, a non-woven fabric, and the like.

For example, the carbon fiber support for the lithium metal negative electrode may have a porosity of 60% to 97%, for example, 60% to 95%, for example, 70% to 95%, for example, 70% to 90%, for example, 75% to 85%. The carbon fiber support for a lithium metal negative electrode according to an embodiment has a very high porosity in the above range, so that a lithium affinity gradient suitable for a large-area electrode may be easily achieved, and the phenomenon of lithium being electrodeposited on the upper portion of the support may be prevented, and internal electrodeposition of lithium may be induced. The pores may be formed using a pore forming agent, and the pore forming agent may be NaCl, sucrose, or a combination thereof, which are harmless to the human body. The porosity of the carbon fiber support for the lithium metal negative electrode may be controlled by the mass ratio of carbon nanotubes (CNTs) and NaCl, as described below, and the pore size of the carbon fiber support for the lithium metal negative electrode may be controlled by the degree of crushing of NaCl. In other words, according to an embodiment, the porosity and pore size may be easily controlled, so that it is possible to manufacture lithium metal batteries having various specifications.

For example, the lithium-containing layer may include a first layer (e.g., a lithium affinity layer) and a second layer (e.g., the lithium non-affinity layer). The lithium concentration in the lithium affinity layer is higher than the lithium concentration in the lithium non-affinity layer. The lithium affinity layer is located between the current collector and the lithium non-affinity layer. The lithium affinity layer may further include a lithium ion affinity element.

in other words, the lithium affinity gradient according to an embodiment may be implemented with two layers, the lithium affinity layer and the lithium non-affinity layer, and the lithium affinity gradient may be a gradient in which the lithium concentration gradually decreases in the direction of the current collector, the lithium affinity layer, and the lithium non-affinity layer.

The lithium ion affinity element is an element that shows a strong affinity for lithium ions, and may include both a metal/non-metal element that forms an alloy with lithium and an element that contains a functional group that has a strong affinity for lithium ions, and may include, for example, silver (Ag), zinc (Zn), gold (Au), aluminum (Al), carbon (C), or a combination thereof.

For example, the conductive carbon fiber may include carbon nanotubes (CNTs), graphite nanofibers (GNFs), or a combination thereof.

The carbon fiber support for the lithium metal negative electrode may further include a binder.

The binder serves to improve the adhesion between the conductive carbon fiber and the pore forming agent and the adhesive strength to the current collector. Examples may include polyvinylidene fluoride (PVDF), vinylidene fluoride-hexafluoropropylene copolymer (PVDF-co-HFP), polyvinyl alcohol, polyacrylonitrile, carboxymethyl cellulose (CMC), starch, hydroxypropyl cellulose, regenerated cellulose, polyvinyl pyrrolidone, polytetrafluoroethylene, polyethylene, polypropylene, ethylene-propylene-diene monomer rubber (EPDM rubber), sulfonated-EPDM, styrene butadiene rubber (SBR), fluoroelastomer, or various copolymers thereof, and may be used alone or a mixture of two or more thereof. For example, it may be polyvinylidene fluoride (PVDF).

The binder may be included in an amount of 10 wt % to 50 wt %, for example, 10 wt % to 30 wt %, for example, 10 wt % to 20 wt %, based on a total weight of the carbon fiber support for the lithium metal negative electrode. When the binder is included in an amount of less than 10 wt % based on the total weight of the carbon fiber support for the lithium metal negative electrode, the binder amount may be too small to produce the film itself, and when the binder is included in an amount of more than 50 wt % based on the total weight of the carbon fiber support for the lithium metal negative electrode, the relative amount of the conductive carbon fiber and the pore forming agent may be affected, making it difficult to easily implement a lithium affinity gradient.

For example, the carbon fiber support for the lithium metal negative electrode may have a thickness of 10 μm to 100 μm, for example, 20 μm to 80 μm, for example, 20 μm to 60 μm, and desirably, may have a thickness of 40 μm. The thickness of the carbon fiber support for the lithium metal negative electrode may be easily controlled by adjusting the casting thickness described below. In other words, since the carbon fiber support for a lithium metal negative electrode according to an embodiment may be controlled through the production of an electrode using a casting method, it is possible to manufacture lithium metal batteries having various specifications using the same.

### Method for Manufacturing Carbon Fiber Support for Lithium Metal Negative Electrode

A method for manufacturing a carbon fiber support for a lithium metal negative electrode according to an embodiment of the present disclosure includes: mixing a conductive carbon fiber treated with a lithium ion affinity element and a pore forming agent to prepare a powder; adding a binder and a solvent to the powder to prepare a slurry; casting the slurry on the current collector and then drying it; casting a mixture of a binder, a solvent, and a powder which is prepared by mixing a conductive carbon fiber that are not treated with a lithium ion affinity element and a pore forming agent, onto the dried slurry, and then drying the mixture; and etching after the drying.

The porous structure (lithium metal support) according to an embodiment may be manufactured with a high porosity by mixing conductive carbon fibers/tubes constituting the structure and a material (pore forming agent) etchable with D.I. water together with a binder, preparing a slurry through ball-milling, and then casting it on a copper foil using a doctor blade, and then etching it with D.I. water after a drying process. A lithium affinity gradient may be implemented by sequentially casting carbon nanotube (CNT) powder subjected to lithium affinity treatment and carbon nanotube (CNT) powder not subjected to lithium affinity treatment into a slurry and then casting them onto copper foil. Through this lithium affinity gradient, internal electrodeposition of lithium may be easily induced and made suitable for large-area applications.

The lithium affinity treatment method is introduced through a process of thermally decomposing lithium affinity materials into carbon fibers/tubes. After soaking carbon fiber/tube powder in an AgNO₃ aqueous solution, the powder is separated through a vacuum filter, and after drying, Ag is introduced into the carbon fiber/tube through a pyrolysis process. The Ag content of carbon-based materials may be controlled by adjusting the concentration of the AgNO₃ aqueous solution. The porous structure may alleviate the aggregation of carbon nanofibers by adding a pore forming agent. At this time, the weight of the porous structure may be reduced to 0.12 mg/cm² or less per 10 μm, enabling the implementation of a battery with high energy per weight/volume.

For example, the pore forming agent may include NaCl, sucrose, or a combination thereof. The NaCl and/or sucrose, and the like may be etched with water alone, which can greatly improve the processability when manufacturing the porous structure (lithium metal support) according to an embodiment of the present disclosure.

According to an embodiment, the porous structure (carbon fiber support for lithium metal negative electrode) may easily control a microscopic structure through the use of micrometer-sized particles and etching and casting methods, and may also easily control a macroscopic structure through the production of the electrode using the casting method. In other words, the method for manufacturing a carbon fiber support for a lithium metal negative electrode according to an embodiment may easily control the microscopic structure and the macroscopic structure simultaneously or selectively, thereby enabling the manufacture of lithium metal batteries having various specifications.

The conductive carbon fiber and the pore forming agent may be mixed in a weight ratio of 1:5 to 1:10, for example, 1:5 to 1:9, for example, 1:6 to 1:8. When the conductive carbon fiber and pore forming agent are mixed in the weight ratio as described above, the porosity in the carbon fiber support for the lithium metal negative electrode produced may be increased, which is advantageous in securing energy density and may also increase resistance to pressure.

With regard to the method for manufacturing a carbon fiber support for a lithium metal negative electrode according to an embodiment, the pore forming agent and binder are as described above, and the remaining components may also be as described above.

As described above, a lithium metal battery manufactured using a carbon fiber support for a lithium metal negative electrode according to an embodiment of the present disclosure may have an excellent cycle-life and, in addition, excellent electrochemical properties, and therefore may be useful in portable devices such as mobile phones, laptop computers, and digital cameras, and electric vehicles such as hybrid electric vehicles (HEVs).

The following examples illustrate embodiments of the present disclosure in more detail. However, the following examples are only examples, and the present disclosure is not limited to the following examples.

### Comparative Example 1: Copper Foil

As a control, copper foil (Cu foil) was used.

### Comparative Example 2: Manufacturing of Conductive Porous Carbon Fiber Structure

Carbon nanofiber powder (CNT powder) and NaCl were mixed in a mass ratio of 1:7 and then, ball-milled to prepare mixed powder. Subsequently, a PVDF binder and N-methyl-2-pyrrolidone (NMP) were added thereto and then, ball-milled again, preparing a slurry. The slurry was cast on a copper foil with a doctor blade and then, dried in a vacuum oven. After the drying, an etching process in deionized (D.I.) water was performed to remove the NaCl, manufacturing a carbon nanofiber (CNT) structure having high porosity.

### Example 1: Manufacturing of Conductive Porous Carbon Fiber Structure Having Lithium Affinity Gradient

The carbon nanofiber powder (CNT powder) treated with lithium affinity Ag and NaCl were mixed in a mass ratio of 1:7 and then, ball-milled, preparing mixed powder. Subsequently, a PVDF binder and NMP were added thereto and then, ball-milled again to prepare a slurry. The slurry was cast on a copper foil by using a doctor blade and then, dried in a vacuum oven. On the dried slurry, a slurry including NaCl prepared by carbon nanofiber powder (CNT powder) having no lithium affinity treatment was cast to implement a lithium affinity gradient. After drying, an etching process in D.I. water was performed to remove NaCl, manufacturing a carbon nanofiber (CNT) structure having high porosity.

### Evaluation 1: XRD and TAG Analysis

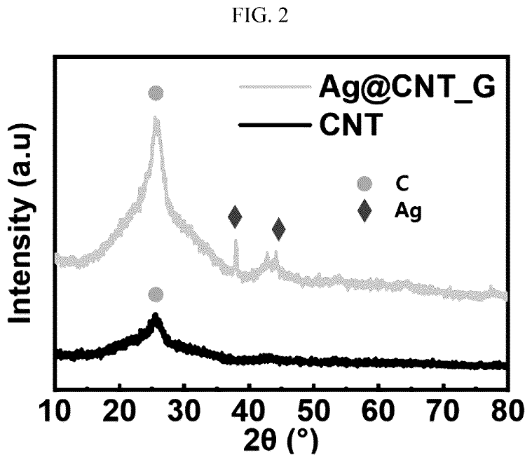

The structure according to Example 1 was analyzed with respect to characteristics. FIG. 2 shows that both CNT peak and Ag peak appeared in the structure when an X-ray Diffraction (XRD) analysis was performed

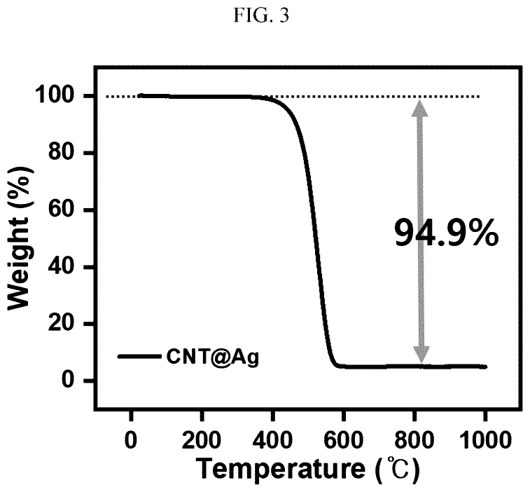

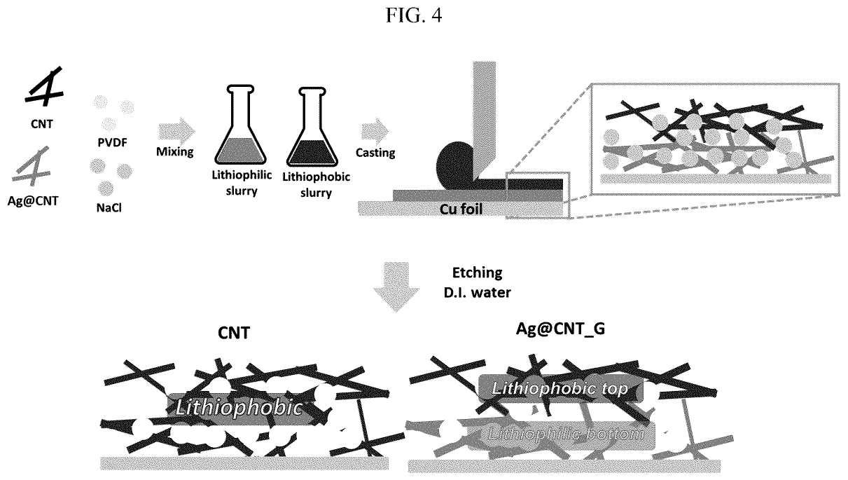

The thermogravimetric analysis (TGA) shows that a CNT ratio was about 94.9%, an Ag ratio was 5.1% (refer to FIG. 3), which was almost similar to 5.19% of another Ag ratio in the Inductively Coupled Plasma (ICP) analysis (refer to Table 1). Table 1 shows ICP analysis data of Example 1.

TABLE 1

| | Weight | Ag |
|---|---|---|
| Material | (mg) | (wt %) |
| CNT | 19.1 | 0 |
| (carbon nanofiber not subjected | | |
| to lithium affinity Ag treatment) | | |
| Ag@CNT | 18.7 | 5.19 |
| (carbon nanofiber subjected to | | |
| lithium affinity Ag treatment) | | |

### Evaluation 2: Porosity by Adjusting NaCl/CNT Ratio

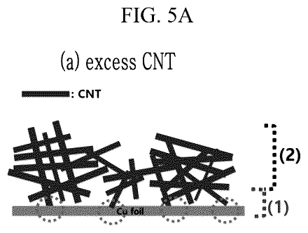

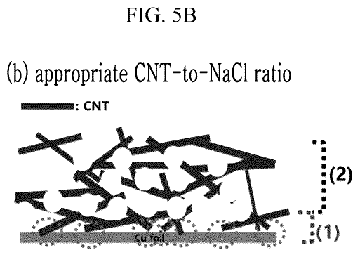

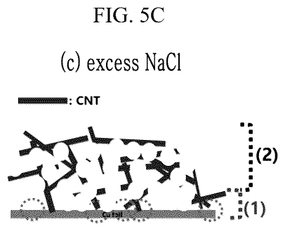

An evaluation of optimizing porosity by adjusting the NaCl/CNT ratio was conducted to optimize the process of Example 1. This was for controlling a portion corresponding (1) of FIGS. 5A to 5C.

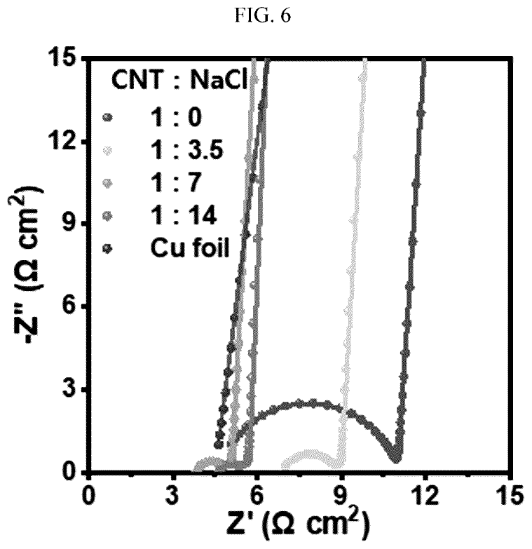

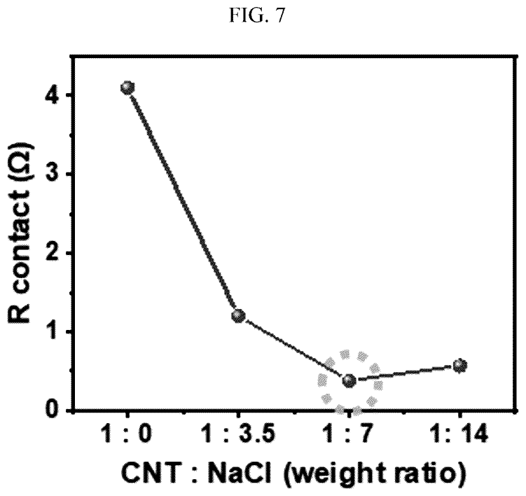

When the CNT ratio was high as shown in FIG. 5A, it was difficult for an electrolyte to penetrate due to no pores between CNTs, causing a problem of decreasing ionic conductivity. (1:0 data of FIGS. 6 and 7)

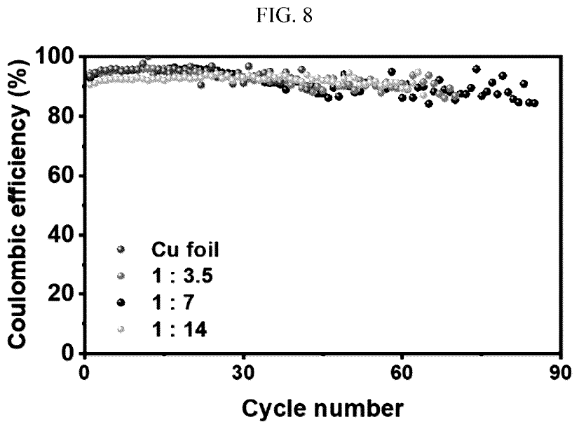

As shown in in FIG. 5C, when forming porosity with NaCl, there was a problem of decreasing electrical conductivity at a higher NaCl ratio than an appropriate level. There was another problem of weakening the contact between current collector and structure and the contact between CNTs, a structure material. (1:14 data of FIGS. 6-8)

Accordingly, an appropriate NaCl ratio is required, wherein FIG. 5B and FIGS. 6 to 8 confirmed 1:7 as the appropriate ratio. Even the data of FIG. 7 confirmed that the ratio of 1:7 exhibited the highest performance.

Additionally, a test on pressure resistance according to porosity was performed. It was confirmed that the higher porosity, the higher stain, when a pressure was applied. When the porosity was reduced to 80% or less, there was no significant difference in the pressure resistance. In other words, it was further confirmed that it was possible to secure energy density with even high porosity, wherein the high ratio of 1:7 (porosity 82%) with high pressure resistance was the most suitable (refer to Table 2). Table 2 shows resistance and resilience to pressure of a structure with controlled porosity.

TABLE 2

| Thickness according to | 0 atm | 3 atm | 5 atm | After recovery |
|---|---|---|---|---|
| surface pressure | (μm) | (μm) | (μm) | (μm) |
| porosity 70% | 32.4 | 31.0 (−4.32%) | 30.7 (−5.25%) | 32.1 |
| porosity 80% | 33.2 | 31.7 (−4.51%) | 31.4 (−5.42%) | 33.5 |
| porosity 90% | 34.7 | 32.9 (−5.19%) | 32.6 (−6.05%) | 33.2 |
| porosity 95% | 32.5 | 30.1 (−7.38%) | 29.7 (−8.62%) | 32.0 |

### Evaluation 3: Electrical Conductivity by Adjusting the Binder Ratio

An evaluation for optimizing electrical conductivity by adjusting a binder ratio was performed in order to optimize the process of Example 1. It was for controlling a portion corresponding to FIG. 5B.

When less than or equal to 10% of the binder was applied, because a film was not formed, after setting a minimum binder ratio at 10%, the test was conducted by increasing the binder ratio to 30 wt % and 50 wt %.

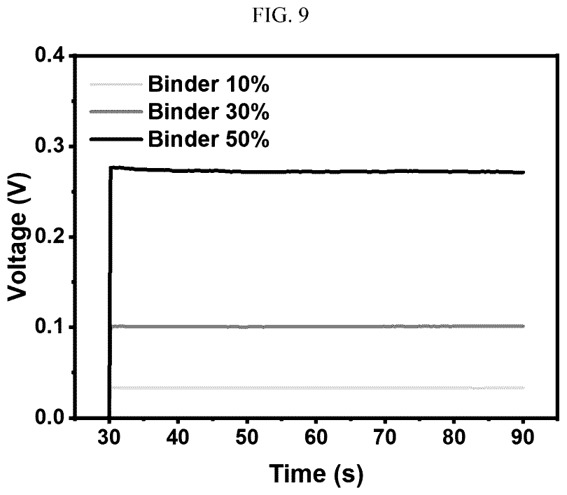

As the binder ratio was increased, the binder more penetrated between the structures, reducing electrical conductivity. (Refer to FIG. 9 and Table 3) Table 3 shows resistance and electrical conductivity results calculated by using the data of FIG. 9.

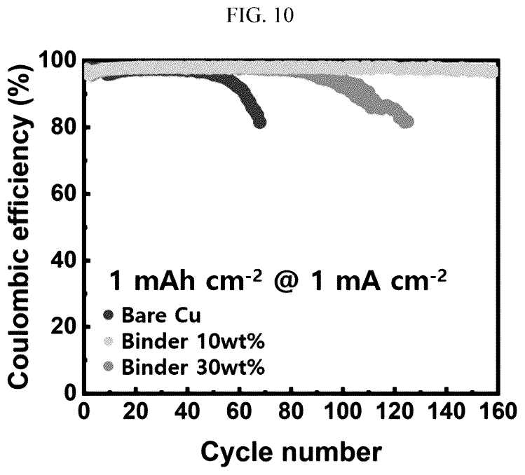

Referring to FIG. 10, in the electrochemical half-cell evaluation, when the binder ratio was the lowest 10%, high performance was achieved, but when the binder ratio was increased to 30%, the performance decreased. In addition, Comparative Example 1 (copper foil) was confirmed to exhibit the lowest performance, which confirmed that the cell performance decreased when the structure was applied.

It was confirmed that the lowest binder ratio capable of forming a structural film of 10% turned out to be an optimal ratio.

TABLE 3

| | Binder 10% | Binder 30% | Binder 50% |
|---|---|---|---|
| L (μm) | 57 | 55 | 58 |
| U (V) | 0.033 | 0.1 | 0.27 |
| ρ (Ω · m) | 9.1 | 27 | 77 |
| σ (S/m) | 0.11 | 0.037 | 0.013 |

### Evaluation 4: Electrochemical Performance

A 170 μm-thick lithium, which was layered respectively on the conductive porous structure according to Comparative Example 2 and Example 1, as a counter electrode and a reference electrode, while using a highly conductive porous structure as a working electrode, was used to test the electrochemical performance at a current density of 1 mA cm⁻² for an electrodeposition time of 1 mAh cm⁻².

In the binder ratio analysis, an electrolyte prepared by dissolving lithium bis(trifluoromethanesulfonyl)imide (LITFSI) salt at a concentration of 1 M in a solvent including DOL (1,3-dioxolane)/DME (1,2-dimethoxyethane) in a volume ratio of 1:1 and 1% (weight percentage) of LiNO₃ was used.

In the electrochemical analysis, an electrolyte prepared by dissolving 0.05 M LiPF₆, 0.8 M LiTFSI, and 0.2 M Lithium difluoro (oxalato) borate (LiDFOB) in a solvent of Ethyl methyl carbonate/Fluoroethylene carbonate (EMC/FEC) (3:1 v/v) was used.

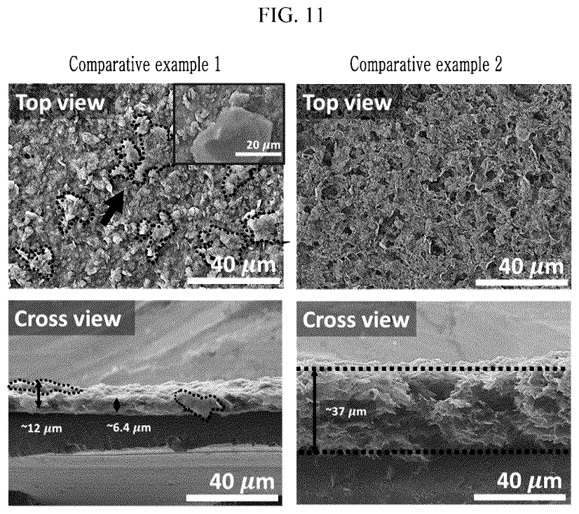

Effect 1: Cross-sectional SEM of carbon fiber structure with and without NaCl application (see FIG. 11)

when NaCl was not applied (Comparative Example 1), CNTs were aggregated together to form a thin (6.4 μm-thick) film, but when NaCl was applied in a ratio of 1:7 (Comparative Example 2), a 37 μm-thick structure with high porosity was fabricated.

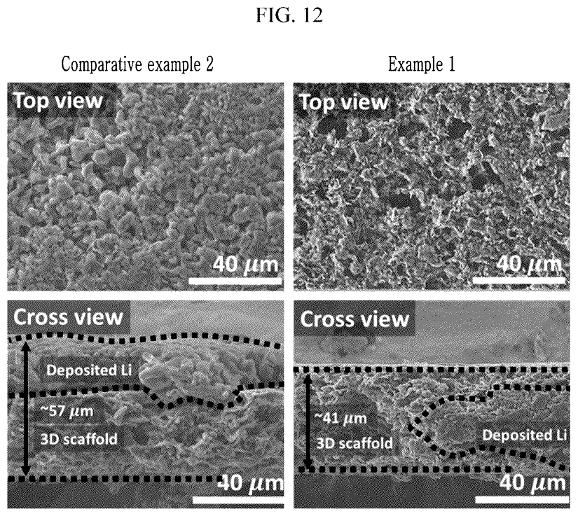

Effect 2: scanning electron microscope (SEM) of Lithium Electrodeposition of Comparative Example 2 and Example 1 (see FIG. 12)

Comparative Example 2 and Example 1 according to silver (Ag) coating or not were subjected to SEM analysis.

The top view of Comparative Example 2 confirmed that lithium was electrodeposited not inside the structure but on the top of the structure. If the lithium was electrodeposited inside the structure, the lithium should not be seen in the top view. Its cross view also confirmed that the lithium was electrodeposited not inside the structure but on the top of the structure (dotted line).

The top view of Example 1 exhibited no lithium but a porous structure alone. In addition, the cross-view analysis also confirmed that the lithium was electrodeposited inside the structure.

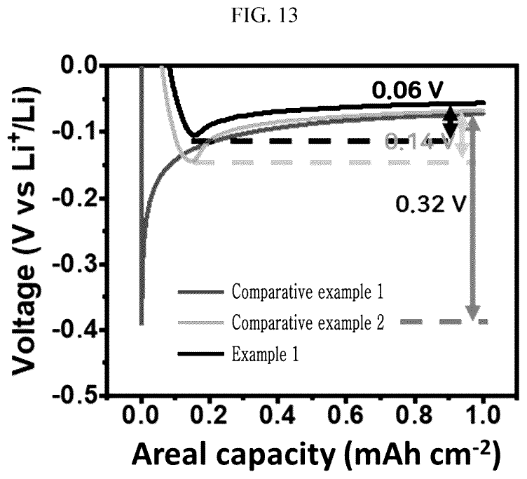

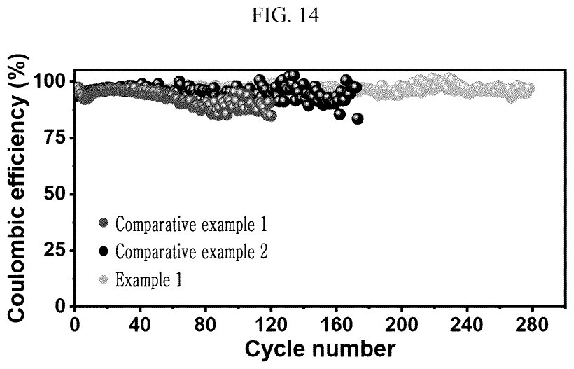

Effect 3: Difference in Nucleation Overvoltage of Comparative Example 1, Comparative Example 2 and Example 1 (see FIG. 13)

Comparative Example 1 was confirmed that a high nucleation overvoltage of 0.32 V occurred due to no affinity for Li.

Comparative Example 2 was confirmed that a relatively low nucleation overvoltage of 0.14 V was formed because CNT had weak affinity for lithium on the surface.

Example 1 additionally included Ag with strong affinity for lithium, compared to Comparative Example 2, exhibited a low nucleation overvoltage of 0.06 V.

While this disclosure has been described in connection with what is presently considered to be practical example embodiments, it is to be understood that the present disclosure is not limited to the disclosed embodiments, but, on the contrary, is intended to cover various modifications and equivalent arrangements included within the spirit and scope of the appended claims. Therefore, the aforementioned embodiments should be understood to be examples but not limiting the present disclosure in any way.

What is claimed is:

1. A carbon fiber support for a lithium metal negative electrode, the carbon fiber support comprising:
a current collector; and
a lithium-containing layer including a conductive carbon fiber and disposed on the current collector;
wherein lithium in the lithium-containing layer has a lithium concentration gradient in which a lithium concentration gradually decreases as a distance from the current collector increases, and
wherein the lithium-containing layer further comprises pores.

2. The carbon fiber support of claim 1, wherein
the carbon fiber support has a porosity in a range of 60% to 97%.

3. The carbon fiber support of claim 1, wherein
the lithium-containing layer comprises a first layer and a second layer,
a lithium concentration in the first layer is higher than a lithium concentration in the second layer,
the first layer is located between the current collector and the second layer, and
the first layer further comprises a lithium ion affinity element.

4. The carbon fiber support of claim 3, wherein
the first layer is a lithium affinity layer.

5. The carbon fiber support of claim 3, wherein
the second layer is a lithium non-affinity layer.

6. The carbon fiber support of claim 3, wherein
the lithium ion affinity element comprises silver (Ag), zinc (Zn), gold (Au), aluminum (Al), carbon (C), or a combination thereof.

7. The carbon fiber support of claim 3, wherein
the conductive carbon fiber comprises a carbon nanotubes (CNT), a graphite nanofiber (GNF), or a combination thereof.

8. The carbon fiber support of claim 1, wherein
the carbon fiber support further comprises a binder.

9. The carbon fiber support of claim 8, wherein
the binder is included in an amount in a range of 10 wt % to 50 wt % based on a total weight of the carbon fiber support.

10. The carbon fiber support of claim 1, wherein
the carbon fiber support has a thickness in a range of 10 μm to 100 μm.

11. A method for manufacturing a carbon fiber support for a lithium metal negative electrode, the method comprising:
mixing a conductive carbon fiber treated with a lithium ion affinity element and a pore forming agent to prepare a powder;
adding a binder and a solvent to the powder to prepare a slurry;
casting the slurry on a current collector;
drying the slurry casted on the current collector;
casting a mixture of a binder, a solvent, and a powder which is prepared by mixing a conductive carbon fiber that are not treated with a lithium ion affinity element and a pore forming agent, onto the dried slurry;
drying the mixture; and
etching the dried mixture after the drying.

12. The method of claim 11, wherein
the conductive carbon fiber and the pore forming agent are mixed in a weight ratio of 1:5 to 1:10.

13. The method of claim 11, wherein
the pore forming agent comprises NaCl, sucrose, or a combination thereof.

14. The method of claim 11, wherein
the binder is included in an amount in a range of 10 wt % to 50 wt % based on a total weight of the slurry.

15. The method of claim 11, wherein
the lithium ion affinity element comprises silver (Ag), zinc (Zn), gold (Au), aluminum (AI), carbon (C), or a combination thereof.

16. The method of claim 11, wherein
the conductive carbon fiber comprises a carbon nanotubes (CNT), a graphite nanofiber (GNF), or a combination thereof.
